(19) United States
(12) Patent Application Publication
(10) Pub. No.: US 2022/0335342 A1
(43) Pub. Date: Oct. 20, 2022

(54) PRIORITIZATION STUDIO BOOKING METHOD

(71) Applicant: Space for Arts, Inc., Wilbraham, MA (US)

(72) Inventors: Elizabeth A. Davison, Wilbraham, MA (US); Karl Ivan Folke Gothner, Wilbraham, MA (US); Joseph Peter Carter, Bristol (GB); Henry Addison, Bristol (GB); Benjamin Reid, Spalding (Lincolnshire) (GB); Thomas David John Coates, Bristol (GB)

(73) Assignee: Space for Arts, Inc., Wilbraham, MA (US)

(21) Appl. No.: 17/617,636

(22) PCT Filed: Jun. 12, 2020
(86) PCT No.: PCT/US2020/037561

§ 371 Date: Dec. 9, 2021

Related U.S. Application Data
(60) Provisional application No. 62/860,590, filed on Jun. 12, 2019.

(51) Int. Cl. G06Q 10/02

(52) U.S. Cl. CPC G06Q 10/02

(57) ABSTRACT

A system and method for managing and processing reservation and hooking of multiple studio spaces in response to competing requests from multiple potential studio users. The process includes development and application of studio and user standards, studio control over user participation, and a priority system with alerts and notifications to allow for multiple tentative retains to he placed on multiple spaces and subsequently resolved prior to award of bookings.

### CROSS-REFERENCE TO RELATED APPLICATION

This application claims the priority benefit of U.S. Provisional Application Ser. No. 62/860,590, filed on Jun. 12, 2019 as a provisional application for the invention claimed herein and also entitled PRIORITIZATION STUDIO BOOKING METHOD. Provisional Application Ser. No. 62/860,590 is entirely incorporated by reference herein as if set forth in full.

### BACKGROUND OF THE INVENTION

One of the biggest problems for photo and video production professionals is finding and booking studio spaces, as each production team has specific requirements that are unique to each and every shoot. The invention herein disclosed is an enhanced virtual marketplace that offers a sophisticated, powerful search tool and simplifies a complex and outdated booking process. The process allows photo and video production professionals to timely and efficiently connect with and resolve potentially conflicting commitments to multiple quality studio spaces around the world.

Booking studio spaces involves different considerations than those related to reserving spaces for events such as business meetings, conventions, weddings, and the like. Automated systems for addressing multiple requests for a single event facility have been developed by others. For example, Hallinen et al. (US 2018/0011859) discloses a networked database management system for reserving event venues that involves a highly computerized “hold, challenge, release” system. As described by Hallinen, the venue details that are stored in a database include such considerations as number of people accommodated in various modes (e.g., seated, outdoor, buffet, etc.), while relevant “customer” information includes “number of guests” and “seating style.” This is not a system that works effectively for reserving studio spaces, including without limitation spaces for acting, architecture, painting, three-dimensional art, photography, graphic design, filmmaking, animation, industrial design, radio and television production broadcasting, and making of music.

Professional production teams have unique requirements that frequently involve specialized space needs and the need to simultaneously line up quality production spaces in multiple locations, sometimes in vastly different geographical locations, for which there may be interest from multiple sources. They normally cannot first visit and evaluate potential studio spaces, but must be able to trust that a booking agent's available spaces will meet certain minimum standards. Similarly, studio owners must be confident that prospective users of their studios meet financial and production quality standards. Thus, there is a need for a system that allows multiple pre-vetted studio spaces located around the globe to be identified, held, and booked efficiently by multiple pre-approved users.

Currently available booking systems allow parties to reserve and pay for (“book”) individual studio spaces. Typically, if the studio owner accepts a booking request, payment is taken through a pre-authorized card payment and the booking is confirmed. A studio owner may also reject a booking request for a variety of reasons, such as holding out for another more valued customer, or simply not wanting to book the studio at the time of the request. Studio owners may also set ad-hoc unavailability dates for their studios, so that any bookings for specified dates and times are rejected.

Current systems are deficient in a number of respects. Among those are their inability to efficiently evaluate and process multiple, often competing requests to tentatively retain numerous quality studios without payment pending confirmation of actual need by prospective users of the spaces. These systems generally are also unable to efficiently meet the needs of prospective studio users that often must identify and preliminarily retain studios in multiple locations for overlapping dates while production and related issues that determine actual location needs are resolved. These failings result in lost bookings and disrupted client relationships for studio owners caused by untimely responses to booking requests and maintenance of tentative booking requests no longer needed and, conversely, excessive pre-production and administrative costs for studio users associated with managing multiple studio space requests and commitments.

The design and solution on which this virtual marketplace invention relies reflect simple elegance to timely locate, make available, and resolve potential competing needs for multiple quality production spaces. The invention offers a seamless, intuitive flow that fosters the human connection and saves time for production teams to focus on the creative aspects of production.

### SUMMARY OF THE INVENTION

The present invention is a unique system and method for addressing the needs of global production teams to tentatively retain multiple, high quality studio spaces in diverse locations for potentially overlapping dates while production issues are resolved. It also provides a system and method for resolving competing requests from different production teams for retaining and booking quality studio spaces. The system includes a vetting of both production spaces and space users to assure quality studios and reliable production team users. The system allows prospective, vetted users to temporarily maintain a relative right to reserve multiple vetted studio spaces without payment or other irrevocable commitment (a “retain”). Unless subsequently “called” by one or more other vetted users as herein explained, each retain, if accepted by the respective studio, will remain in place until a specified time (the “retain period”). Any number of vetted users may place a retain on each studio for any given set of dates, effectively being placed in a virtual retain “queue” for each space for dates in which retains overlap. Conversely, a vetted user may place a retain on any number of studio spaces in geographically diverse locations for a given set of dates. If there are no other retains encompassing any of the dates or if the party is first in the queue for one or more spaces, it can book the studio of its choice at any time prior to the close of the respective retain period for the studio space. The system then removes the user awarded the studio for the subject dates from the queue for other studios it has retained for any of those days, alerts those other studios that the user is no longer in their queues for those dates, adjusts those queues, and alerts other parties with retains on groups of studios that included the subject property for any of the now booked dates that their retain on the studio for those dates has been dissolved so that they may consider booking or placing a call on one of their alternative retains. If a call is made on a studio retained by one or more other users, the system provides notice to those other users, allows a period for them to match the call, awards the space to the matching user with highest priority, adjusts the queue for other vetted studios as appropriate, provides an alert to all other affected studios and users, and allows those other users to take steps, by booking or calling, to secure an alternative vetted studio.

### BRIEF DESCRIPTION OF THE DRAWING

FIG. 1 provides an overview of the process for establishing sets of vetted studios and vetted users,

FIG. 2 illustrates an exemplary flow of information and decision making relating to a single studio.

FIG. 3 provides an example of the process flow for establishing a set of user retains.

FIG. 4 provides a second example of the process flow for establishing a set of user retains,

FIG. 5 illustrates an example of the call process applied to overlapping retains between two sets of user retains.

FIG. 6 illustrates an example of the call process with multiple matches applied to overlapping retains among multiple sets of user retains.

FIG. 7 illustrates an example of the call process with a single match applied to overlapping retains among multiple sets of user retains.

FIG. 8 illustrates an example of the call process with all matches declined applied to overlapping retains among multiple sets of user retains.

FIG. 9 illustrates the overlap of a single retain with non-overlapping retains of multiple other users.

### DETAILED DESCRIPTION

In the following paragraphs, the present invention is described in detail by way of example with reference to the attached drawings. The examples shown should be considered as exemplars, rather than as limitations, on the present invention. As used in this specification, “present invention” refers to any one of the embodiments described herein and any equivalents. Furthermore, reference to a feature or various features of the present invention does not mean that all claimed embodiments or methods must include the referenced feature or features.

Throughout this description there is reference to the “system.” The system herein referred to can be any coordinated collection of databases, processors, communication devices, transmitters, receivers, and/or decision makers, which may include both computerized and human elements. The process described herein is applicable whether carried out in whole or in part automatically by electronic devices or deliberately by humans.

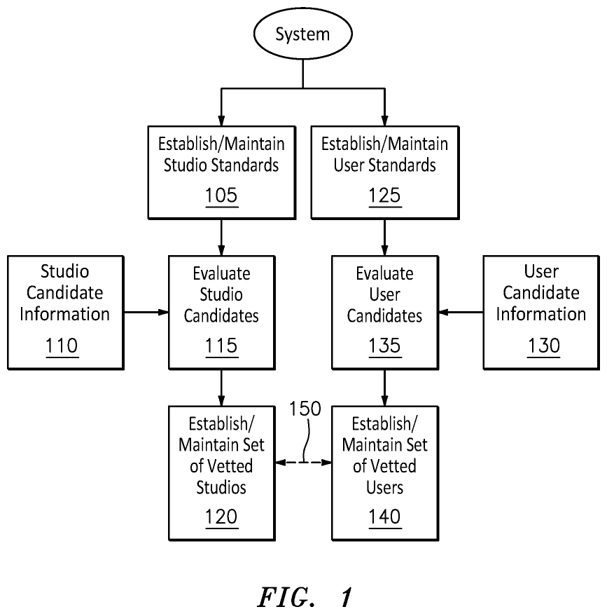

The present invention relies upon assessing participants pursuant to standards as outlined in FIG. 1. Establishing those standards for acceptable studios 105 can be accomplished in a variety of ways, but inevitably derives from knowledge of the unique needs of the production industry. The standards may involve, without limitation, size, location, age, character, and other features of production spaces. These standards may become categories within a first database.

A next step may be identifying potential production spaces and vetting them relative to the established standards 115. Production teams searching worldwide for studio spaces need to be able to rely upon a system that has filtered out substandard or otherwise inappropriate spaces. The vetting process carried out by the system may include, among other things, visiting, viewing, measuring, and researching potential studios 110. The system may produce decisions as to whether each production space meets and exceeds the established standards. The process may be ongoing as additional candidate spaces become available over time and formerly acceptable spaces deteriorate or otherwise cease to meet the standards.

These initial steps lead to the establishment of a set of vetted studios at any given point in time comprising vetted spaces that meet or exceed the studio standards 120. While all vetted studios must meet the standards, the set may nonetheless be diverse. This diversity may include without limitation various locations, dimensions, lighting features, amenities, and reflections of overall character. The database of vetted studios should include a variety of information about each studio. In addition to the features mentioned above, information may include, for example, price, accessibility, prior reviews, regulatory and legal issues, and cultural constraints. The information should be accurate, comprehensive, and current. The set of vetted studios may be maintained within the first database or a second database.

A second set of standards should also be developed and maintained. Quality production studios generally expect that only quality production teams will be allowed access, so that standards should also be developed for those teams 125. Applicable standards for the potential studio users may include, without limitation, financial underwriting, insurance, experience, and reputation. The standards form the foundation of a user database that is maintained with or within the other databases.

Potential studio users may be vetted against the user standards. Studios may not have the ability to efficiently screen each of the many, diverse production teams from varying regions and cultures who may wish to use the studio. The process herein disclosed includes an application process conducted on behalf of all participating studios 130 that evaluates each potential user against the user standards 135. Potential users unable to meet these standards are not allowed to participate in the process. The evaluations are ongoing, as additional candidate users apply and others cease to qualify over time.

A result is the establishment of a set of vetted potential users that meet or exceed the set of user standards 140. Like the range of studios that meet the studio standards, the set of vetted users may be diverse, with varying backgrounds, financial strengths, nationalities, talents, and/or cultural identities. In this manner, a database of vetted, quality users is established.

The need for both diversity and quality means that the vetted user database may include a variety of information. The information about the production team and each of its members may include not only that typically found in a quality resume, but also reputational information as may be reflected in prior experience, recommendations, and reviews. This information must be accurate, comprehensive, and current, and it must be kept secure.

The studios within the vetted studio database and the production teams reflected in the vetted user database may be allowed to view certain information in the others' database 150, consistent with appropriate privacy and security considerations. For example, the vetted users may further develop production ideas by reviewing the studio data for ideas and inspiration for location, ambience, and style.

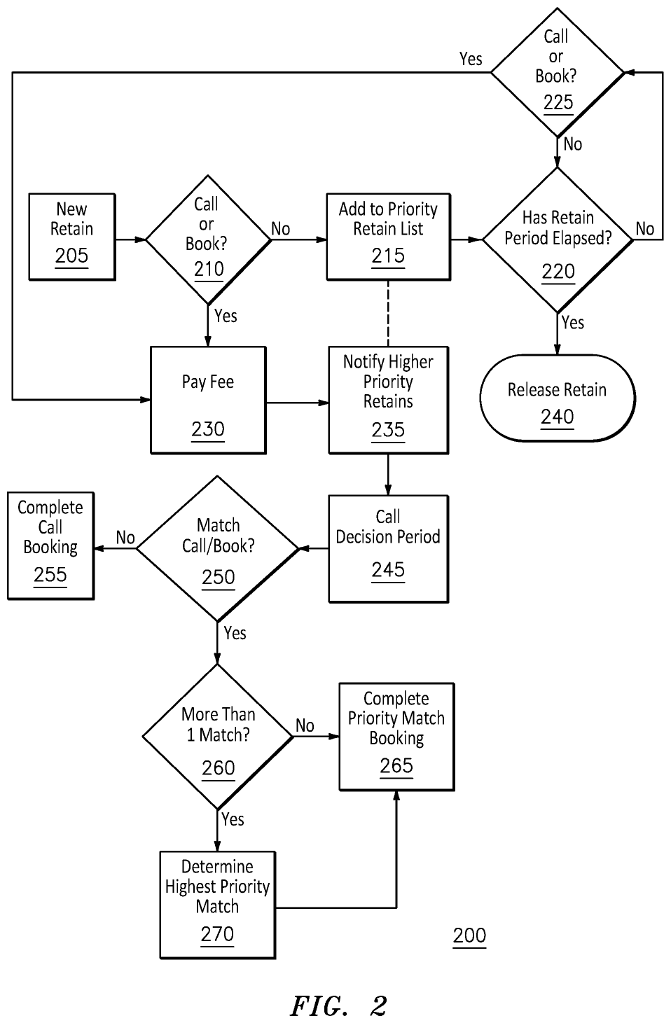

The following is an example of how these databases and processes may be employed by the system when dealing only with a single studio, as shown in FIG. 2. As illustrated there, the system allows prospective studio users to temporarily maintain a relative right to reserve a space without payment or other irrevocable commitment (a “retain”) 205. Unless the user chooses to book the studio, which may require a call as discussed below if already retained by another party 210, the retain, if accepted by the studio, will remain in place until a specified time (the “retain period”) 220. Any number of users may be allowed a retain on the studio for a given date, effectively being placed in a virtual retain queue for overlapping dates 215. If there are no other retains encompassing the dates, or if the party is first in the queue, it can book the studio at any time prior to the close of the retain period by, for example, confirming and paying a stipulated fee 230.

Until booking is effectuated, other parties can call the retain on the studio. To call, a prospective user of the space may be required to make a payment 230. The system notifies the studio of the requested call, which may accept or decline it, thus allowing the studio to decide on whether to await a better offer on a property for which a valuable retain may be pending. Upon acceptance of the call, the system notifies the users with a higher priority in the retain queue that a call has been made 235, and a finite period is then allowed for the priority retainers to commit to match the call in a specified manner 245, If there is a match 250 by one or more users with higher priority retains 260, the call is defeated and the matching party with the highest priority 270 is awarded the studio for the subject dates 265. On the other hand, if the call is not matched within the specified time, the call is successful and becomes a booking for the user that made the call 255.

The system becomes more complex when a plurality of vetted users place multiple retain requests upon multiple studios. In one example, the system may receive a first set of one or more requests from a first vetted studio user seeking to retain a plurality of studios 310. The requests may be submitted in any of a variety of forms, such as via a web site, email, app, fax, or telephone. The requests may encompass a number of studios located in different regions and different countries. The dates for which these retains may be requested by the first vetted user for the various studios may overlap.

Upon receipt of the requests, the system informs each of vetted studios identified within the first set of requested studios of the request from the first vetted studio user 331, 332, 333. Notice similarly may be provided in any number of ways, including without limitation by email, app, text, fax, and telephone.

Whether or not a studio accepts a vetted user for a date or set of dates may be at the studio's discretion, which may first access data on the vetted user made available by the system 340. The system may provide the studio with a specified amount of time within which to provide notice of acceptance, without which the system, by default, may notify the vetted user either that the retain has not been accepted or has been accepted. If the studio, within the designated time period, notifies the system that the studio accepts the first vetted user 351 (or by default 352, if so set up), the system places a retain on the property on behalf of the first vetted user for its requested dates and so notifies the first vetted user. In this manner, the first vetted user becomes a first accepted user. This process is repeated with respect to each of the studios within the first set of requests from the first accepted user, thus creating a first set of user retains. A retain request rejected by the studio is no longer considered with respect to that studio 353.

The identity of the first accepted user and each studio, with corresponding dates, for which a retain for the first accepted user has been approved comprise a first set of user retains 360. Each retain may be time limited. At any time until the retain period is ended, and absent a call from a subsequent accepted user, the first accepted user can book any of its retained studios. That booking may involve paying a fee.

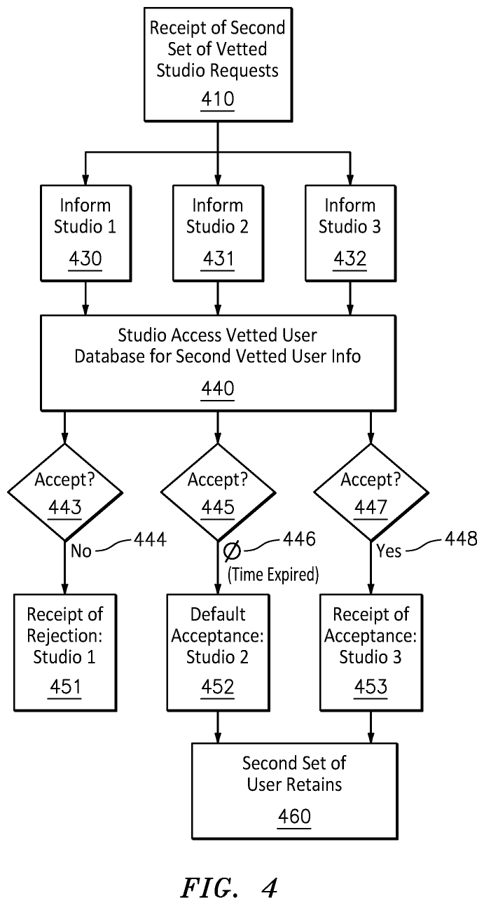

As shown in FIG. 4, the system may receive a second set of one or more requests from a second vetted studio user seeking to retain studios 410. The requests may encompass a number of studios, which may be the same as or different from, in whole or in part, the studios that the first accepted user has retained. For purposes of this example only, the studios in the second set of studio requests are assumed to be the same set of three studios as in the first set of studio requests. The dates for which the second set of retains may be requested for the various studios may overlap the dates of the first accepted user's retains.

Upon receipt of the requests, the system informs each of vetted studios within the second set of requested studios of the relevant request from the second vetted studio user 431, 432, 433. As with the first vetted studio user, notice may be provided in any number of ways. Whether or not a “retain” is accepted for any given studio for any date or set of dates may again be at the discretion of the studio, which may access data on the second vetted user maintained by the system 440. The system may provide a studio with a specified amount of time within which to provide notice of acceptance, without which the system notifies the user that the retain has not been accepted, or has been accepted, depending upon the default setting. If the studio, within the designated time period, notifies the system that the studio accepts 448 (or by default 446 if that is the applicable setting), the system places a retain on the property for the second vetted user for the requested dates and so notifies the user, who then becomes a second accepted user. This process is repeated with respect to each of the studios within the second set of requests of the second accepted user. A retain request from the second vetted user rejected by the studio is no longer considered 451.

The identity of the second accepted user and each vetted studio, with corresponding dates, for which a retain for the second accepted user has been approved comprise a second set of user retains 460 that is stored in a system database. At any time until the retain period is ended, if no prior accepted user has retained a studio in the set of studios that have accepted the second accepted user with an overlapping date, and absent a call from a subsequent accepted user, the second accepted user can book any of its retained studios by paying a required fee.

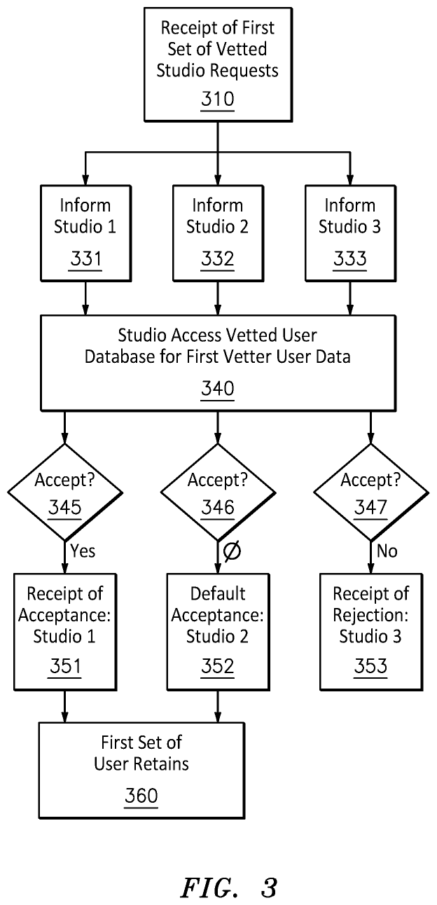

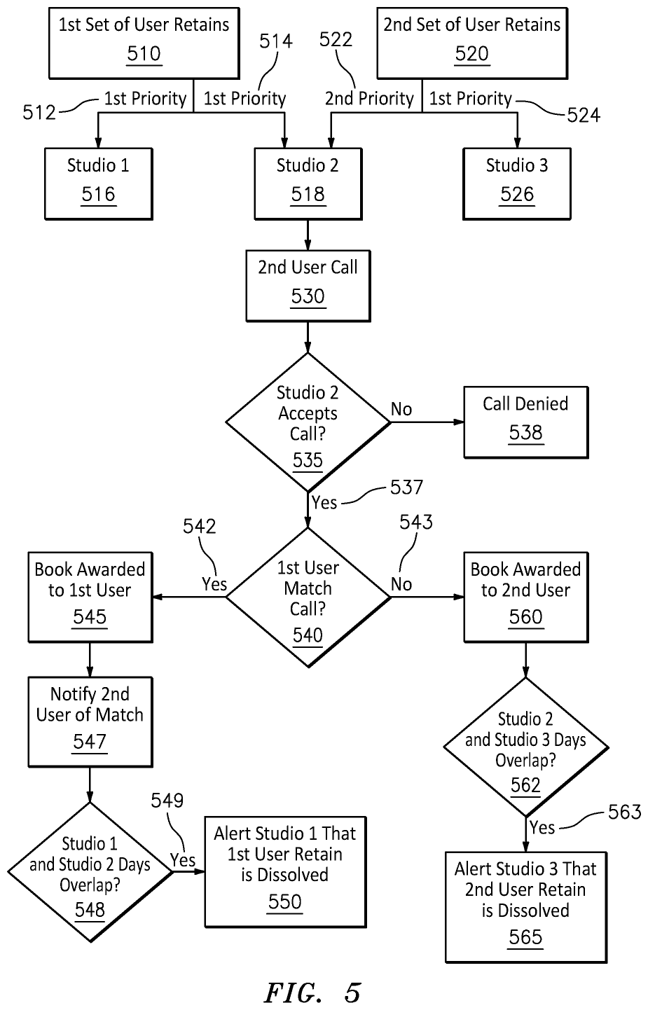

Conflict may occur when the requests from the second accepted user include a studio for a date for which the first accepted user has a retain. Consider the situation presented by FIG. 3 and FIG. 4, where both the first set of user retains 360 and the second set of user retains 460 include studio 2, and assume that the respective retains on the studio are for sets of dates that overlap by at least one day. The situation is further depicted in FIG. 5. Absent further action by either user, the first accepted user has a first priority retain 512 on studio 1 516 and a first priority retain 514 on studio 2 518, while the second accepted user has a first priority retain 524 on studio 3 526, but a second priority retain 522 on studio 2 518 for the period that includes the overlapping dates. In such a case, no payment would be required from either user to maintain their respective retains.

The second accepted user, however, may, for example, have an immediate need to book a space for its production, and thus may require closure as to which of its retains it will book. It also may prefer studio 2 518 over studio 3 526. In such a case, the second accepted user may make a “call” 530 on the mutually desired studio 518 by, for example, making a required payment. The studio is first asked whether it will approve the call 535, and may then accept or decline it. This step allows the studio, by rejecting a call, to keep intact a potentially more valuable retain in anticipation that it may evolve into a valuable book. Such a situation may arise, for example, if the retain of the first accepted user is for a full month, while the retain of the second accepted user who has made the call is for only a single day in the middle of that month. To allow that call to proceed may mean destroying the opportunity for realization of a one month's booking by the first accepted user in exchange for the one day booking, if the first accepted user is not yet able to commit to the studio at the time of the call.

If the studio does approve the call 537, the first accepted user is provided a finite period to match it, which may be by providing a specified payment, which may or may not be the same as the payment required for the call 540. If the first user matches within the call period 542, the booking is awarded to the first user for its requested dates 545, either with or without further approval by the studio. The system notifies the second user that its call was matched 547. The system may also refund any call payment of the second accepted user, and continue to maintain the retains of the other studios in the second accepted user's set of requested studios. The second accepted user can then immediately book an alternative space within its set of retains by making appropriate payment on any studio for which it has a first priority retain. Any studio on which is has a second (or lower) priority retain is subject to the conflict resolution process described above.

The system may also provide an important alert and notification function. In this example, if the dates the first accepted user has booked for studio 2 overlap any dates of the first accepted user's retain for studio 1 548, 549 the system may alert studio 1 that the first accepted user's retain for that studio is cancelled 550. This relieves the burden and inefficiencies for studio 1 of carrying a retain that is no longer needed. Instead, the system would adjust any queue of priorities pending for the studio by eliminating any unnecessary retains.

If the first accepted user does not match the call of the second accepted user 543 on studio 2, the book may be awarded to the second accepted user 560. The system will then continue to maintain the other retains within the first accepted user's set of retained studios, which the first accepted user can book at any time prior to the expiration of the retain period, assuming no higher priority retain exists on the alternative retained studio.

The alert function may similarly apply in this situation. As just discussed with respect to studio 1, if the dates now booked for studio 2 overlap any dates of the second accepted user's retain for studio 3 562, 563, the system may alert studio 3 that the second accepted user's retain for that studio is cancelled 565 and adjust any queue for that studio. The process would thus relieve studio 3 of the burden of carrying unneeded and meaningless retains.

Like branches on a tree, the decision making process gets substantially more complex as the number of accepted users and retained studios increase with multiple overlapping dates. For example, expanding the above example, the system may receive a third set of one or more requests from a third vetted studio user seeking to retain potential studio spaces. The requests may also encompass multiple studios, which may be the same as or different, in whole or in part, from the studios that the first vetted studio owner and/or the second vetted studio owner was allowed to retain. The dates for which the third vetted user may request retains for the various studios may overlap with the dates for the studios retained by either or both of the first accepted and second accepted users.

The system informs each of the studios within the third set of requests upon receipt of the requests from the third vetted user. Whether or not a studio accepts a retain for any date or set of dates requested by the third vetted user remains at the discretion of the studio. The system may provide the studio with a specified amount of time within which to provide notice of acceptance, without which the system notifies the third vetted user that, depending upon the system's default setting, the retain has or has not been accepted. If the studio, within the designated time period, notifies the system that the studio accepts, the system places a retain on the property for the third vetted user for the requested dates and so notifies the user, who then becomes a third accepted user. This process is repeated with respect to each of the studios within the third set of requests. A similar process may be applied to a fourth and subsequent vetted users.

The identity of the third accepted user and each vetted studio, with corresponding dates, for which a retain for the third accepted user has been approved comprise a third set of user retains that is stored in a system database. As with the first and second accepted users, at any time until the retain period is ended, if no accepted user has a higher priority retain on a studio for a date or set of dates for which the user has a retain, and absent a call from a subsequent accepted user with a lower priority retain, the third accepted user may book the studio by, for example, paying a required fee. This process may be also carried out by a fourth and subsequent vetted users.

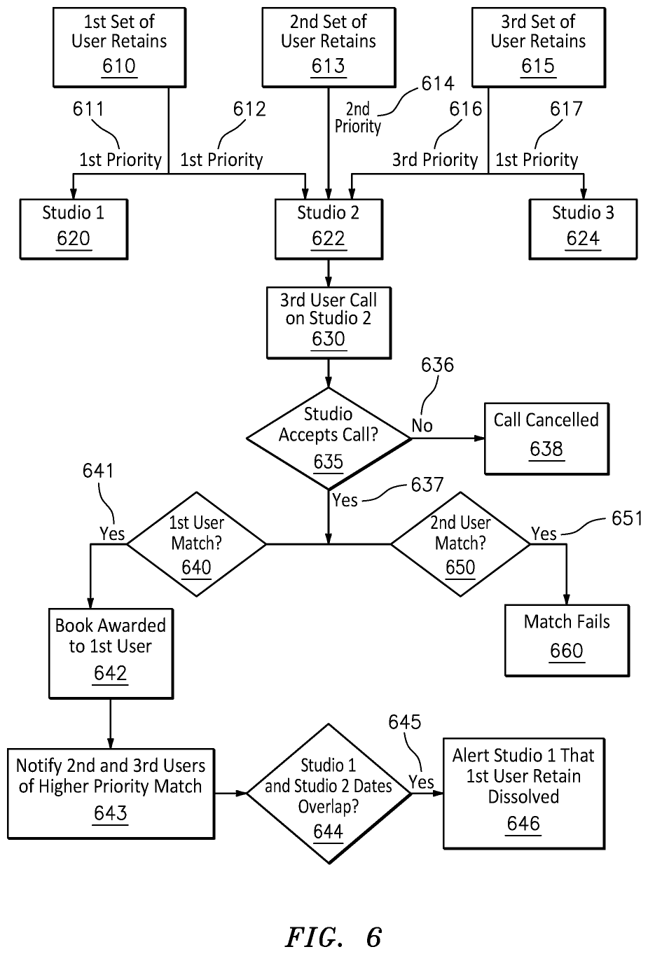

The third accepted user's retains, however, may conflict with one or more of the retains of the first accepted user and/or the second accepted user. The situation may be addressed in the manner shown in FIG. 6, which depicts a situation in which one of the studios in the third set of user retains, studio 2 622, overlaps with at least one date of the retain on the studio by the first accepted user, which has a first priority retain on that studio for that date 612, that is the same as at least one date of the retain on the studio by the second accepted user, which has a second priority retain on it 614. In such a case, the third accepted user may have a third priority retain on studio 2 616, while also maintaining a first priority retain on studio 3 617.

Like the second accepted user discussed above, the third accepted user may have an urgent need to book a studio for its production and thus a need to make a quick decision as to which of its retained studios it will book. In such a case, the third accepted user may have a preference for studio 2 622 and thus may make a call on it 630. The call may need to be approved by the studio to proceed 635, as discussed above. If the studio approves the call 637, the system informs both the first accepted user and the second accepted user of the call on the mutually desired space. Within the call period, both the first accepted user and the second accepted user must make a decision of whether to match the call 640, 650.

If both the first and the second accepted users match the call of the third accepted user 641, 651; the system informs the first accepted user that it has been awarded the book for the studio 642. If the dates booked for studio 1 overlap any dates of the first accepted user's retain for studio 1 644, the system may alert studio 1 that the accepted user's retain for that studio is cancelled 646. It may also inform the second accepted user that its match has failed 660, and similarly inform the third accepted user that its call has failed 643. The third accepted user can then either: (1) immediately book an alternative space within its third set of studio requests for which it has a first priority retain 617 by, for example, making a required payment; or (2) make a call on another studio for which it may have another lower priority retain.

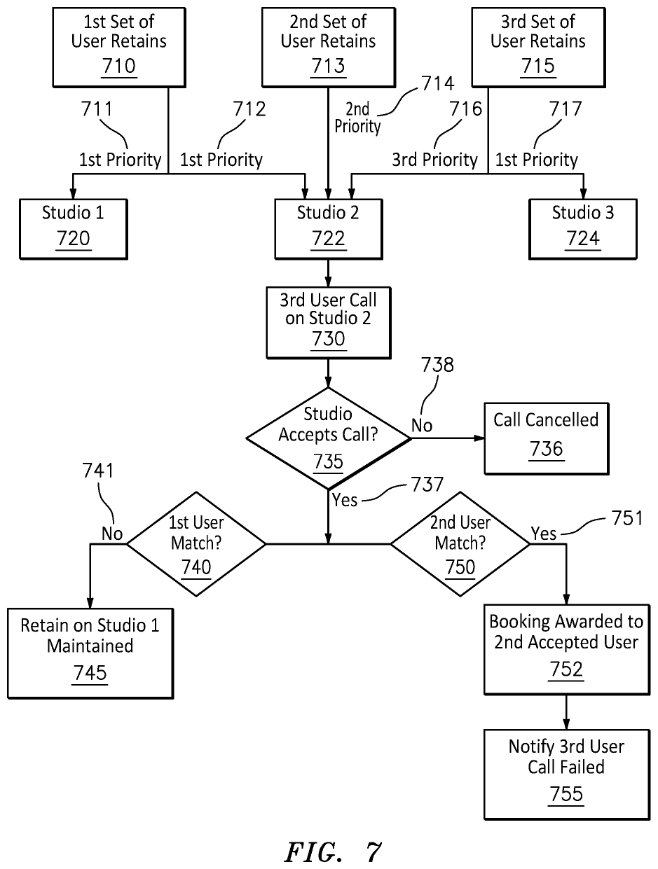

FIG. 7 depicts a variation on this scenario. As in the scenario above, the third accepted user has a preference for studio 2 722 and makes a call on it 730. The call may need to be approved by the studio to proceed 735, as discussed above. If the studio approves the call 737, the system informs both the first accepted user and the second accepted user of the call on the mutually desired space. In this case, however, within the call period, only the second accepted user matches the call 750, 751. The system thus informs the second accepted user that its match has succeeded and it is awarded the booking 752, and similarly informs the third accepted user that its call has failed 755. Because the first accepted user did not match the call on studio 2, its first priority retain of studio 1 is maintained 745. As above, the third accepted user can then either: (1) book an alternative space within its third set of studio requests for which it has a first priority retain 717; or (2) make a call on another studio for which it may have another lower priority retain.

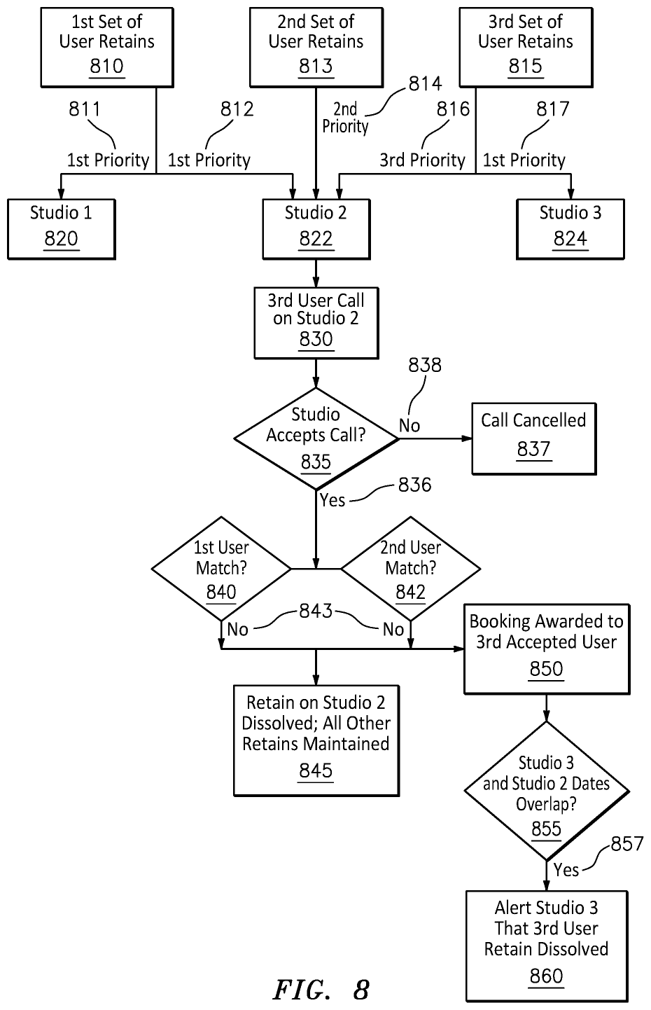

FIG. 8 illustrates the situation described above except neither of the first or second accepted users matches the call 843. In such a case, the system informs the third accepted user that it has been awarded the booking for studio 2 for its requested dates 850. If the dates associated with the third accepted user's retain on studio 3 overlap with any date encompassed within its booking for studio 2 855, 857, the system may inform studio 3 that the third accepted user's retain for that studio has been dissolved 860. The system will then continue to maintain the other retains within the first and second accepted users' respective set of retained studios 845.

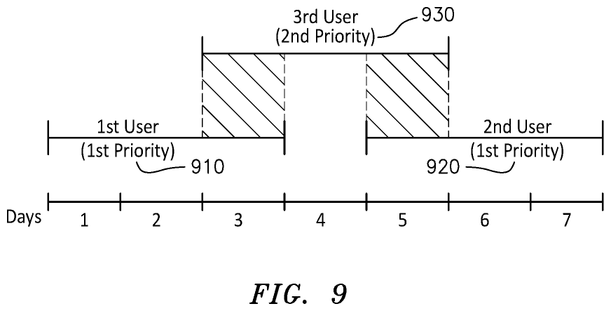

The situation may also arise where a third accepted user has a second priority retain for the same property relative to both a first accepted user and a second accepted user that each has a first but separate priority retain on the same property. For example, as shown in FIG. 9, a first accepted user may have a first priority retain on the studio for days 1 through 3 910, while a second accepted user may have a first priority retain on the same property for days 5 through 7 920. A third accepted user may subsequently receive a retain for the same property for days 3 through 5 930. In such a situation, the third accepted user's retain would be second priority to the retains of both the first accepted user and the second accepted user. Should the third accepted user place an approved call on the studio, then both the first and the second accepted users would need to decide whether to match the call. If either of those users did match the call, the third accepted user's call would be defeated. For example, if only the second accepted user matched the call, it would be awarded the booking for days 5 through 7, and the retain of the third accepted user for days 3 through 5 would be cancelled. The retain of the first accepted user for days 1 through 3 would remain as a retain due to the failure of the call on its retain to be successful, even though the first accepted user had not matched the call to secure the booking for those days.

The system may be operated to allow each accepted studio at all times to maintain primary control over retains and bookings. For example, the system may provide that a studio may at any time cancel a retain for any reason. A user, of course, should be able to cancel any of its retains at any time. Cancellation of one retain should not impact the priority of any other retains of the accepted user on any other studios.

The system also may be operated to allow users to lint their requests for studios for any given set of dates. For example, a vetted user may need to rent two studios in one facility or two studies geographically separate for a shoot that will encompass both locations. Thus, a user may submit its request for the two studios with the stipulation that they be processed together such that a call on one studio constitutes a call on both studios for the identified set of dates.

The converse may also occur: that is, a vetted user may seek to reserve more than one studio for unrelated shoots on the same set of dates. The system thus may also be operated to provide the additional feature of allowing a vetted user to maintain multiple, separate sets of retains for the same set of dates, with each set of requests treated independently. In such a situation, for example, an award of a booking to the user from its first set of retains would not result in the termination of its retains on studios within its second set of retains.

As a person well versed in the relevant trade would know, the system described herein is applicable to any number of users and studios. Similarly, there is no inherent limit on the number of retains or priorities that may apply to any given studio for any given date. While the permutations may increase exponentially, the principles and steps described above can be applied to retain, call, alert, resolve conflicting retains on, and book any number of quality studios.

Insofar as the description above and the accompanying drawing disclose any additional subject matter that is not within the scope of the claims below, the inventions are not dedicated to the public and the right to file one or more applications to claim such additional inventions is reserved. While the inventions claimed involve the steps stated below, the invention encompasses any rational ordering of the steps presented.

1. A system and method for reserving studios comprising:
a. Maintaining a database containing a set of vetted studios and corresponding information about the vetted studios within the set of vetted studios;
b. Maintaining a database containing a set of vetted users and corresponding information about the vetted users within the set of vetted users;
c. Receiving a set of one or more retain requests from each of a plurality of vetted users,
i) each set of retain requests from each said vetted user
(1) including at least a request to retain reservations for one or more vetted studios comprising a set of acceptable studios for the vetted user, and
(2) the retain request encompassing one or more specified dates for which the retain of the set of acceptable studios is requested, said specified dates comprising a set of dates for the vetted user,
ii) whereby each said set of retain requests includes an overlapping retain request consisting of
(1) a vetted studio common to each set of retain requests of said vetted users and
(2) encompassing at least one date included within each user's set of dates;
d. Obtaining approval from the common vetted studio of a plurality of the retain requests for the common vetted studio from said vetted users with an overlapping retain request for the common vetted studio;
e. Assigning a retain priority to the retain request of each approved vetted user for the common vetted studio whereby
i) the approved vetted user for the common vetted studio that first submitted its set of retain requests is assigned first or highest retain priority, and
ii) other approved vetted users for the common vetted studio are assigned lower retain priority in descending order from earliest to latest of the date and time in which each submitted its set of retain requests;
f. Receiving a call on the common vetted studio, consisting of a predefined required action or set of actions, from an approved vetted user with a retain priority other than first or highest;
g. Informing all approved vetted users with a retain priority higher than the user making the call that a call has been placed on the common vetted studio for its respective overlapping retain;
h. Providing a limited period for each approved vetted user with a retain priority higher than the user making the call to match the call by undertaking one or more specified actions;
i. If one or more higher priority approved vetted users with an overlapping retain matches the call within the limited period:
i) Confirming, with the matching approved vetted user with the highest retain priority, a first booking of the studio that was the subject of the call;
ii) informing each of the other studios, included within the set of retain requests with the overlapping retain from the approved vetted user receiving said first booking, that the user's retain on the other studio has been cancelled;
iii) continuing to maintain all retains, other than the overlapping retains, of the approved vetted users not receiving the first booking who had an overlapping retain on the common studio;
j. If one or more higher priority users with an overlapping retain on the common studio does not match the call within the limited period:
i) confirming a second booking of the retain with the approved vetted user that made the call;
ii) informing each of the other studios, included within the set of retain requests with the overlapping booking from the approved vetted user receiving said second booking, that the user's retain on the other studio has been cancelled;
iii) continuing to maintain all retains, other than the overlapping retain, of the approved vetted users not receiving the second booking who had an overlapping retain on the common studio.

2. The system and method of claim 1, wherein the call is cancelled without award of a booking if approval of the call is not received from the studio that is the subject of the call.

3. The system and method of claim 1, wherein the approved vetted user with first or highest priority may secure booking for its overlapping retain at any time before a call is made on the overlapping retain.

4. The system and method of claim 1, wherein the predefined required action necessary to make a call is payment of a specified fee.

5. The system and method of claim 1, wherein creating the database containing the set of vetted studios and corresponding information about the vetted studios within the set of vetted studios includes:
a. Evaluating on an ongoing basis a plurality of studios against a set of studio standards;
b. Establishing and modifying on an ongoing basis a set of vetted studios comprising the studios that meet or exceed the set of studio standards.

6. The system and method of claim 1, wherein creating the database containing the set of vetted users and corresponding information about the vetted users within the set of vetted users includes:
a. Evaluating on an ongoing basis a plurality of users against a set of user standards;
b. Establishing and modifying on an ongoing basis a set of vetted users comprising users that meet or exceed the set of user standards.

7. A system and method for reserving studios comprising:
a. Maintaining a database containing a set of vetted studios and corresponding information about the vetted studios within the set of vetted studios;
b. Maintaining a database containing a set of vetted users and corresponding information about the vetted users within the set of vetted users;
c. Receiving a first set of retain requests from a first vetted user, which set of retain requests includes at least a request to retain reservations for one or more specified dates, comprising a first set of dates, for a first set of acceptable studios, comprising a subset of the set of vetted studios;
d. Informing each acceptable studio within the first set of acceptable studios of the request from the first vetted user to retain the acceptable studio for the first set of dates;
e. Receiving from each acceptable studio within the first set of acceptable studios either:
i) a notice of acceptance of the request from the first vetted user;
ii) a notice of rejection of the request from the first vetted user, or
iii) no notice of acceptance or rejection, whereby an acceptance or rejection is determined on behalf of the acceptable studio for the first vetted user pursuant to a system default setting;
f. Eliminating from the first set of retain requests any studio that has not accepted the retain request of the first vetted user, thus creating a modified first set of retain requests;
g. Notifying the first vetted user that its retain request for each acceptable studio within the modified first set of retain requests is accepted, whereby the first vetted user may also be considered a first acceptable user;
h. Assigning for the first acceptable user a first priority retain to each of the retain requests in the modified first set of retain requests for which no other user has a retain that includes a date within the first set of dates;
i. Receiving a second set of retain requests from a second vetted user; which set of retain requests includes at least a request to retain one or more specified dates, comprising a second set of dates; for a second set of acceptable studios, comprising a subset of the set of vetted studios, wherein at least one of said acceptable studios is a first overlapping studio in that:
i) it is the same studio as a studio within the first set of acceptable studios for which the first accepted user has a first priority; and
ii) one date within the second set of dates is included in the first set of dates;
j. Informing each acceptable studio within the second set of acceptable studios of the request from the second vetted user to retain the acceptable studio within the second set of acceptable studios;
k. Receiving from each acceptable studio within the second set of acceptable studios either:
i) a notice of acceptance of the request from the second vetted user,
ii) a notice of rejection of the request from the second vetted user, or
iii) no notice of acceptance or rejection, whereby an acceptance or rejection is determined on behalf of the acceptable studio for the second vetted user pursuant to a system default setting;
l. Eliminating from the second set of retain request any vetted studio that has not accepted the retain request of the second vetted user, thus creating a modified second set of retain requests;
m. Notifying the second vetted user that each acceptable studio within the modified second set of retain requests has accepted its retain request, whereby the second vetted user may also be considered a second accepted user;
n. Assigning to the second accepted user:
i) a first priority retain for any acceptable studio within the modified second set of retain requests for which no other accepted user has a retain that includes a date within the second set of dates;
ii) a second priority retain for any first overlapping studio in the modified second set of acceptable studios for which no other accepted user except the first accepted user has a retain that includes a date within the second set of dates:
o. Receiving from the second acceptable user a call for a first overlapping retain;
p. Informing the first accepted user of the call on the first overlapping retain and providing a limited period for the first accepted user to match the call by undertaking one or more specified actions;
q. If the first accepted user matches the call,
i) confirming with the first accepted user the booking of the retain on the studio that was the subject of the call;
ii) informing each of the other studios within the modified first set of acceptable studios that the first accepted user's retain on the studio has been cancelled; and
iii) continuing to maintain other retains of the second accepted user, if any;
r. If the first accepted user does not match the call of the second accepted user:
i) confirming with the second accepted user the booking of the retain on the studio that was the subject of the call;
ii) informing each of the other studios within the modified second set of acceptable studios that the second accepted user's retain on the studio has been cancelled; and
iii) continuing to maintain other retains of the first accepted user, if any.

8. The system and method of claim 7, wherein creating the database containing the set of vetted studios and corresponding information about the vetted studios within the set of vetted studios includes:
a. Evaluating on an ongoing basis a plurality of studios against a set of studio standards;
b. Establishing and modifying on an ongoing basis a set of vetted studios comprising the studios that meet or exceed the set of studio standards.

9. The system and method of claim 7, wherein creating the database containing the set of vetted users and corresponding information about the vetted users within the set of vetted users includes:
a. Evaluating on an ongoing basis a plurality of users against a set of user standards;
b. Establishing and modifying on an ongoing basis a set of vetted users comprising users that meet or exceed the set of user standards.

10. The system and method of claim 7, wherein the call is cancelled if approval of the call is not received from the studio that is the subject of the call.

11. The system and method of claim 7, wherein matching a call by undertaking one or more specified actions includes confirming booking of a retain on the studio subject to the call by making a specified payment.
